(19) United States
(12) Patent Application Publication
(10) Pub. No.: US 2017/0268455 A1
(43) Pub. Date: Sep. 21, 2017

(54) WATER JACKET FOR CYLINDER HEAD

(71) Applicants: HYUNDAI MOTOR COMPANY, Seoul (KR); KIA MOTORS CORPORATION, Seoul (KR)

(72) Inventor: Youngbae YANG, Anseong-si (KR)

(21) Appl. No.: 15/260,685

(22) Filed: Sep. 9, 2016

(30) Foreign Application Priority Data
Mar. 15, 2016 (KR) 10-2016-0031085

(51) Int. Cl. F02F 1/40; F01P 3/02; F02F 1/42

(52) U.S. Cl. CPC F02F 1/40; F02F 1/4264; F01P 3/02; F01P 2003/024; F02F 2001/4207

(57) ABSTRACT

A water jacket for a cylinder head provided inside a cylinder head including a protruded part formed with an exhaust outlet exhausting an exhaust gas includes an upper water jacket for moving a coolant on an exhaust passage connected with the exhaust outlet inside the protruded part, a lower water jacket for moving a coolant under an exhaust passage connected with the exhaust outlet inside the protruded part, and at least one connection part mutually connecting the upper water jacket and the lower water jacket to enable the flow of coolant to a side of the exhaust outlet from the inside of the protruded part.

### CROSS-REFERENCE TO RELATED APPLICATION

This application claims the benefit of priority to Korean Patent Application No. 10-2016-0031085, filed with the Korean Intellectual Property Office on Mar. 15, 2016, the entire contents of which are incorporated herein by reference.

### TECHNICAL FIELD

The present disclosure relates to a water jacket for a cylinder head. More particularly, the present disclosure relates to a water jacket for a cylinder head for increasing a flow stream of a coolant inside an exhaust outlet in a cylinder head in which an exhaust outlet is integrally formed.

### BACKGROUND

In general, a portion of heat generated from a combustion chamber of an engine is absorbed by a cylinder head, a cylinder block, intake/exhaust valves and a piston.

When a temperature is excessively increased, the listed constituent parts may undergo thermal deformation or an oil film in an inner wall of the cylinder may be damaged such that lubrication failure may be caused, thereby causing a thermal defect.

Such a thermal defect may cause abnormal combustion such as combustion failure, knocking and the like, thereby causing serious damage such as melting of the piston. In addition, thermal efficiency and output may be deteriorated. On the contrary, excessive cooling of the engine may cause deterioration of an output and fuel consumption efficiency and low-temperature abrasion of the cylinder. Accordingly, a temperature of the coolant should be appropriately controlled.

In such an aspect, a water jacket is provided in the inside of a cylinder block and a cylinder head of a conventional engine, and a coolant circulating in, or around or on, the water jacket cools metal surfaces such as the periphery of a spark plug that corresponds to the combustion chamber, an exhaust port and the periphery of a valve sheet.

On the other hand, the exhaust outlet may be integrally formed to be protruded at one side such that the cylinder head connected with each exhaust opening of the combustion chamber through the exhaust passage is applied to the vehicle, to decrease a temperature of an exhaust gas exhausted through each exhaust outlet, and the water jacket may be formed at the protruded portion.

However, in the above conventional water jacket, as the inflowing coolant inflows to cool the exhaust passage, the flow of the coolant may be concentrated in the protruded portion such that the flow rate of the coolant deteriorates.

Also, as the flow rate of the coolant deteriorates, a cooling efficiency of each combustion chamber of the cylinder head may deteriorate such that the entire temperature of the cylinder head increases. Accordingly, the entire durability of the engine may also deteriorate.

The above information disclosed in this Background section is only for enhancement of understanding of the background of the disclosure and therefore it may contain information that does not form the prior art that is already known in this country to a person of ordinary skill in the art.

### SUMMARY

Accordingly, the present disclosure to solve the above-described problems provides a water jacket for a cylinder head increasing the flow stream of the coolant inside the protruded part with the relatively higher temperature in the cylinder head in which the protruded part formed with the exhaust outlet is integrally provided to decrease the temperature of the protruded part exhausting the exhaust gas, thereby improving the cooling efficiency and the entire durability of the cylinder head.

A water jacket for a cylinder head according to an exemplary embodiment of the present disclosure as a water jacket for a cylinder head provided inside a cylinder head including a protruded part formed with an exhaust outlet exhausting an exhaust gas may include an upper water jacket for moving a coolant on an exhaust passage connected with the exhaust outlet inside the protruded part; a lower water jacket for moving a coolant under an exhaust passage connected with the exhaust outlet inside the protruded part;

and at least at least one connection part mutually connecting the upper water jacket and the lower water jacket to enable a flow of coolant to a side of the exhaust outlet from the inside of the protruded part.

The connection part may include a first connection part respectively formed at both sides of the exhaust outlet inside the protruded part with reference to a width direction of the exhaust outlet inside the protruded part and connects the upper water jacket and the lower water jacket; and a second connection part connecting the inside of each first connection part.

The first connection part may be disposed in a direction vertical to the upper water jacket and the lower water jacket.

The second connection part may be formed by connecting an inner center in a vertical direction of the first connection part.

The first connection part and the second connection part may form an “H” shape.

The exhaust outlet may include a first exhaust outlet disposed upward and a second exhaust outlet downward at a predetermined interval in a vertical direction at a side center of the protruded part.

The second connection part may be formed inside the protruded part between the first exhaust outlet and the second exhaust outlet.

As described above, according to the water jacket for the cylinder head according to an exemplary embodiment of the present disclosure, in the cylinder head in which the protruded part having the exhaust outlet is integrally provided, by increasing the flow stream of the coolant inside the protruded part having the relatively high temperature, the temperature of the protruded part exhausting the exhaust gas decreases, thereby improving the entire cooling efficiency of the cylinder head.

Also, by improving the cooling efficiency through an overheating preventing of the protruded part, a crack and a damage of the cylinder head may be prevented and the durability of the cylinder head may be improved.

### BRIEF DESCRIPTION OF THE DRAWINGS

FIG. 1 is a perspective view of a cylinder head with a water jacket for a cylinder head according to an exemplary embodiment of the present disclosure.

FIG. 2 is a perspective view of a water jacket core showing a shape of a water jacket for a cylinder head in the shape of a core according to an exemplary embodiment of the present disclosure.

FIG. 3 is a view showing a flow stream of a coolant in a water jacket for a cylinder head according to an exemplary embodiment of the present disclosure.

### DETAILED DESCRIPTION

An exemplary embodiment of the present disclosure will hereinafter be described in detail with reference to the accompanying drawings.

Prior to the detailed descriptions, while this disclosure will be described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

Components unrelated to the description will be omitted in order to clearly describe the present disclosure, and like reference numerals may be used to describe like components throughout the present specification.

Further, in the drawings, the sizes and the thicknesses of the components are exemplarily provided for the convenience of description, and the present disclosure is not limited to those embodiments shown in the drawings, and dimensions and thicknesses may be exaggerated to clearly show parts and regions.

Throughout this specification and the claims which follow, unless explicitly described to the contrary, the word “comprise” or variations such as “comprises” or “comprising” will be understood to imply the inclusion of stated elements but not the exclusion of any other elements.

In addition, the terms “ . . . unit”, “ . . . means”, “ . . . part”, and “ . . . member” described in the specification mean units of a general configuration performing at least one function or operation.

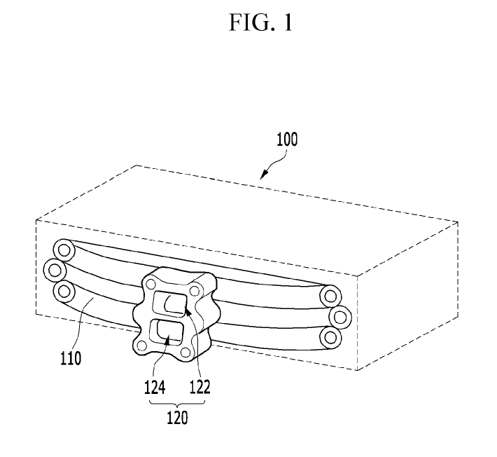

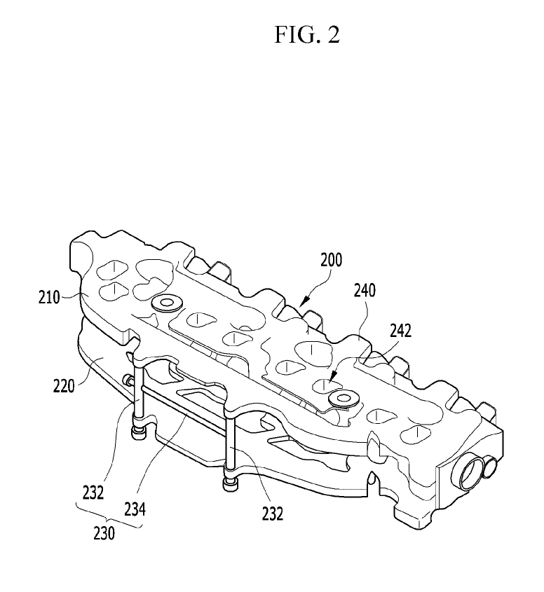

FIG. 1 is a perspective view of a cylinder head with a water jacket for a cylinder head according to an exemplary embodiment of the present disclosure, and FIG. 2 is a perspective view of a water jacket core showing a shape of a water jacket for a cylinder head in the shape of a core according to an exemplary embodiment of the present disclosure.

Referring to FIG. 1, a cylinder head 100 provided with a water jacket for a cylinder head 200 inside according to an exemplary embodiment of the present disclosure may include a protruded part 110 formed with a exhaust outlet 120 for exhausting an exhaust gas.

Here, the exhaust outlet 120 may include a first exhaust outlet 122 disposed upward and a second exhaust outlet 124 disposed downward at a predetermined interval in a vertical direction of the cylinder head 100 on a side, center, or a side center, of the protruded part 110.

Each above-described exhaust outlet 120 may be connected with a combustion chamber of a cylinder to exhaust the exhaust gas exhausted from each combustion chamber to an exhaust line.

The water jacket 200 provided inside the above-configured cylinder head 100, as shown in FIG. 2, may include an upper water jacket 210, a lower water jacket 220 and a connection part 230.

First, the upper water jacket 210 may be formed to move the coolant on an exhaust passage connected with the first exhaust outlet 122 of the exhaust outlet 120 inside the protruded part 110.

The lower water jacket 220 may be formed to move the coolant under the exhaust passage connected with the second exhaust outlet 124 of the exhaust outlet 120 inside the protruded part 110.

Here, the upper water jacket 210 and the lower water jacket 220 may be integrally formed to be respectively protruded from the main water jacket 240 formed inside the cylinder head 100 toward the upper portion and the lower portion of the protruded part 110.

That is, the upper water jacket 210 may be formed upward inside the protruded part 110, and the lower water jacket 220 may be formed downward inside the protruded part 110.

On the other hand, the main water jacket 240 may include four valve holes 242 disposed along a length direction, and each valve hole 242 m respectively formed at a position corresponding to each combustion chamber.

In the present exemplary embodiment, the four valve holes 242 are formed to positions corresponding to each combustion chamber in a four-cylinder engine having four combustion chambers, however the present disclosure is not limited thereto and the positions and the number of the valve holes 242 may be changed and applied depending on the cylinders of the engine and the positions of the combustion chambers within the engine.

Also, the connection part 230 may be formed to mutually connect the upper water jacket 210 and the lower water jacket 220 to move the coolant in the protruded part 110 to the side of the exhaust outlet 120.

Here, the connection part 230 may include a first connection part 232 and a second connection part 234.

First, the first connection part 232 may be respectively formed at both sides with reference to a width direction of the exhaust outlet 120 inside the protruded part 110. This first connection part 232 may mutually connect the upper water jacket 210 and the lower water jacket 220.

Here, the first connection part 232 may be disposed in a direction vertical to the upper water jacket 210 and the lower water jacket 220.

Also, the second connection part 234 may connect the inside of each first connection part 232.

The second connection part 234 may be formed to connect the inner center in the vertical direction of the first connection part 232.

As above-configured, the entire shape of the first connection part 232 and the second connection part 234 may be formed in the shape of an “H”.

That is, the second connection part 234 is formed inside the protruded part 110 between the first exhaust outlet 122 and the second exhaust outlet 124.

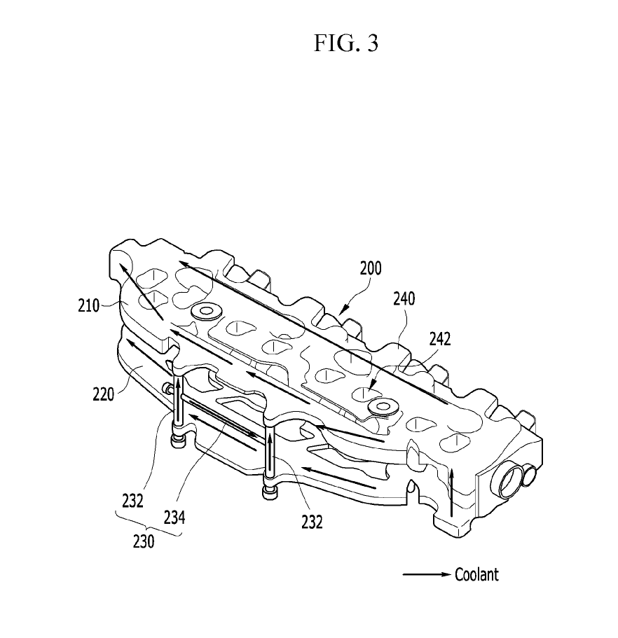

FIG. 3 is a view showing a flow stream of a coolant in a water jacket for a cylinder head according to an exemplary embodiment of the present disclosure.

Referring to FIG. 3, the coolant inflowing into the main water jacket 240 respectively flows to the upper water jacket 210 and the lower water jacket 220.

Here, the coolant flows in the inside of the protruded part 110 from the upper water jacket 210 and the lower water jacket 220 through the first connection part 232 and the second connection part 234.

Thus, the coolant passing through the inside of the protruded part 110 may include the flow stream through the upper and lower water jacket 210 and 220 and the connection part 230.

Accordingly, the coolant passing through the connection part 230 may smoothly cool the protruded part 110 formed with the first and second exhaust outlets 122 and 124 having the relatively high temperature due to the exhaust of the exhaust gas. That is, the coolant flowing to the connection part 230 prevents the temperature of the protruded part 110 where the exhaust outlet 120 is positioned from be excessively increased.

Accordingly, if the above-configured water jacket for the cylinder head 200 according to an exemplary embodiment of the present disclosure is applied, as the flow stream of the coolant increases inside the protruded part 110 having the relatively high temperature in the cylinder head 100 in which the protruded part 110 having the exhaust outlet 120 is integrally provided, the temperature of the protruded part 110 exhausting the exhaust gas decreases, thereby improving the entire cooling efficiency of the cylinder head 100.

Also, by improving the cooling efficiency through an overheating prevention of the protruded part 110, a crack and a damage of the cylinder head 100 may be prevented, and the durability of the cylinder head 100 may be improved.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A water jacket for a cylinder head provided inside a cylinder head including a protruded part formed with an exhaust outlet exhausting an exhaust gas, comprising:
an upper water jacket for moving a coolant on an exhaust passage connected with the exhaust outlet inside the protruded part;
a lower water jacket for moving a coolant under an exhaust passage connected with the exhaust outlet inside the protruded part; and
at least one connection part mutually connecting the upper water jacket and the lower water jacket to enable the flow of coolant to a side of the exhaust outlet from the inside of the protruded part.

2. The water jacket of claim 1, wherein the connection part includes:
a first connection part respectively formed at both sides of the exhaust outlet inside the protruded part with reference to a width direction of the exhaust outlet inside the protruded part, and connects the upper water jacket and the lower water jacket; and
a second connection part for connecting the inside of each first connection part.

3. The water jacket of claim 2, wherein the first connection part is disposed in a direction vertical to the upper water jacket and the lower water jacket.

4. The water jacket of claim 2, wherein the second connection part connecting an inner center in a vertical direction of the first connection part.

5. The water jacket of claim 2, wherein the first connection part and the second connection part are formed in the shape of an “H”.

6. The water jacket of claim 2, wherein the exhaust outlet includes a first exhaust outlet disposed upward and a second exhaust outlet downward at a predetermined interval in a vertical direction at a side center of the protruded part.

7. The water jacket of claim 6, wherein the second connection part is formed inside the protruded part between the first exhaust outlet and the second exhaust outlet.
